(19) United States
(12) Patent Application Publication
(10) Pub. No.: US 2010/0094754 A1
(43) Pub. Date: Apr. 15, 2010

(54) SMARTCARD BASED SECURE TRANSACTION SYSTEMS AND METHODS

(75) Inventors: Jeronimo Bertran, San Diego, CA (US); Javier Bertran, Mexico City (MX)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: Global Financial Passport, LLC, Chula Vista, CA (US)

(21) Appl. No.: 12/250,276

(22) Filed: Oct. 13, 2008

(51) Int. Cl. G06Q 40/00; G06K 9/00; G06K 19/06

(52) U.S. Cl. 705/44; 382/115; 235/494

(57) ABSTRACT

Systems and methods for authorizing financial transactions are described. A request for execution of the financial transaction from a requesting party includes at least one biometric signature of the requesting party and the request is authorized based on identification of the biometric signature in a repository of signatures and a history of prior transactions executed on behalf of the requesting party. The repository may include signatures stored in encrypted form on a smartcard.

### CROSS-REFERENCE TO RELATED APPLICATIONS

This application is related to concurrently filed U.S. Patent Application titled “Smartcards For Secure Transaction Systems,” which is incorporated herein in its entirety.

### BACKGROUND OF THE INVENTION

1. Field of the Invention

The present invention relates generally to secured transactions and more particularly to authenticating parties to a transaction.

2. Description of Related Art

Title III of the USA PATRIOT Act, entitled “International Money Laundering Abatement and Financial Anti-Terrorism Act of 2001,” requires financial institutions to conform to a know your customer (“KYC”) identification program policy in order to combat money laundering on the international stage. Two challenges are associated with the prevention of money laundering. First, it is often difficult to identify the true origin of financial transactions, particularly because, in a great number of instances, no information or false information is provided regarding an individual performing a transaction. Second, knowledge of prior transactions performed by an individual is not available. It is common practice for certain individuals to perform multiple transactions on different location and/or under different names to take advantage of the lack of scrutiny given to performance of small financial transactions.

Conventional smartcards, chip cards and integrated circuit card (“ICC”) are open to susceptible to forgery, theft and alteration, thereby compromising the integrity of systems relying on these cards for authentication purposes. These cards, which typically comprise embedded integrated circuits that can process information, include content arranged according to a smartcard mapping. The mapping of a card is similar to a directory structure in a traditional computer operating system where different files may be maintained and whereby security conditions can be defined for creating, updating and reading data from these files. The security conditions in smartcard files are generally managed by secret keys and secret codes which are used with specialized cryptographic hardware on the card that allow the use of on board algorithms such as RSA and DSA. The most widely used cryptographics in smartcards are 3DES (Triple DES) and RSA. The key set is usually loaded (DES) or generated (RSA) on the card either at the initialization or personalization stage. In conventional systems application development for a smartcard, developers must be provided with confidential documentation of the mapping design along with the key set required to access the files that they will need. The communication of smartcard mappings and key sets to developers and others creates a risk of compromise of smartcard security.

### BRIEF SUMMARY OF THE INVENTION

Certain embodiments of the present invention comprise systems and methods for verifying histories of financial transactions performed by individuals on different locations by using a biometric online authorization system. In certain embodiments, methods include obtaining a financial transaction history of one or more individuals using a biometric signature to distinguish transactions even if the individual provides a different name for each transaction or he/she performs transactions at multiple locations. The biometric signature may include a fingerprint, an iris scan, a palm print and/or any suitable biometric information.

Aspects of the present invention include the use of secure and reliable forms of identification credentials issued to individuals and company officials for presentation to and validation by financial institutions. Such scrutiny exceeds the KYC due diligence requirement mandated by the PATRIOT Act and the Bank Secrecy Act and offers financial institutions and government bodies improved security and assistance in preventing identity theft fraud, money laundering, and terrorist financing.

According to certain aspects of the invention, financial transactions can be monitored and controlled using biometric smartcards. Certain embodiments provide systems and methods for certifying the identity of an individual wishing to perform cash-based financial transactions. The systems and methods provide for identifying individuals that perform cash transactions by using a smartcard that maintains biometric templates of the individual. A common identification paradigm may be implemented for secure money transactions and appropriate security assurance can be achieved by verifying the claimed identity of individuals that perform financial transactions through financial institutions, such as exchange windows and banks.

Certain embodiments of the invention provide systems and methods for designing smartcard maps and for producing secure mapping definition files which provide simple and consistent methods for developers to write applications which interact with smartcards.

Certain embodiments of the invention provide systems and methods for performing data binding with smartcards thereby facilitating simplified and consistent methods for applications to interact with data in the smartcard. Smartcard fields can be bound to data from a variety of data sources and special data handling can be defined in the mapping itself through dynamic code.

### BRIEF DESCRIPTION OF THE DRAWINGS

FIG. 1 shows a block schematic of a system according to certain aspects of the invention.

FIG. 2 depicts a method of authorization according to certain aspects of the invention.

FIG. 3 shows a schematic of a system for enrolling and personalizing a smartcard according to certain aspects of the invention.

FIG. 4 is a flowchart illustrating certain smartcard based transactions according to certain aspects of the invention.

FIG. 5 is a schematic showing a development process according to certain aspects of the invention.

FIGS. 6-8 are code samples according to certain aspects of the invention.

FIG. 9 depicts an authorization process according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Aspects of the present invention relate to smartcard, chip card, ICCs and other portable (e.g. pocket-sized) system that includes embedded integrated circuits and that can be used for authentication and identification in secured transactions. For example, embodiments may substitute mobile communication devices for smartcards. Mobile communications devices include cell-phones, Email client devices, portable computers, as well as multimedia devices used for entertainment and other purposes such as MP3 players, video streaming devices, cameras, etc. It is contemplated that systems and methods described in this disclosure can easily be embodied in mobile communication and/or entertainment devices and that, although the descriptions below refer to physically connected or docked cards, mobile devices embodying aspects of the present invention may communicate with a secure transaction terminal using wireless means. Consequently, embodiments of the invention can comprise programmable devices that are capable of receiving and processing data, typically using preloaded applications and, further, the devices are typically required to be capable of communicating results, through wireless connection or by other means.

For the purposes of this discussion, descriptions will be addressed to examples of ICCs including memory cards containing only non-volatile memory storage components and optional security logic and microprocessor cards comprising volatile memory and microprocessor components. These ICCs may be referred to herein as smartcards for the purpose of describing examples of embodiments. It will be assumed that data stored on a smartcard may vary in different ways from the data stored on data sources and that data may require conversion or processing before data exchange is performed.

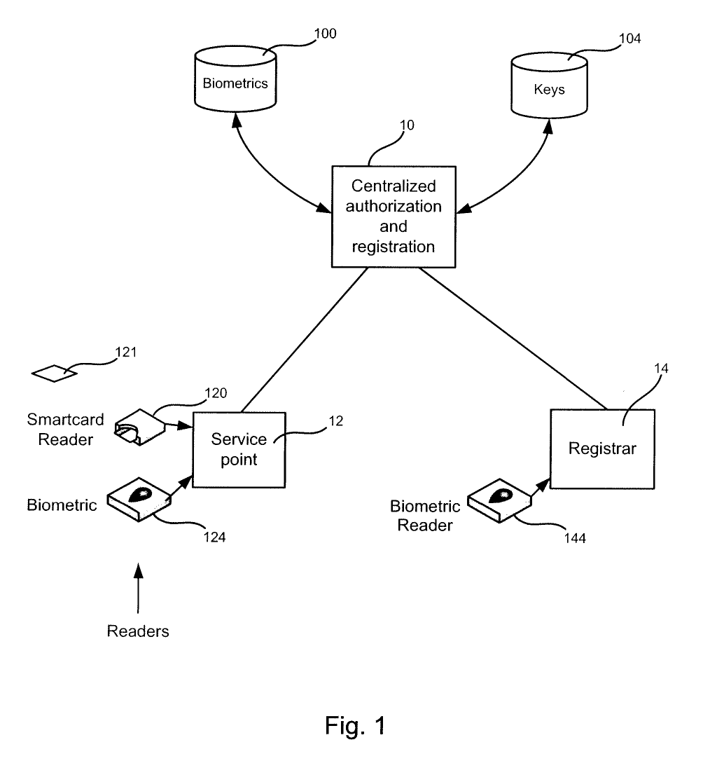

In certain embodiments of the invention, systems and methods are provided for securely identifying parties to a transaction and for determining whether the transaction should be authorized based on the identification of the parties and histories of transactions conducted by the parties. FIG. 1 diagrammatically depicts a simplified example of a system for authorizing transactions according to certain aspects of the invention. A centralized authorizing system 10 is deployed to receive transaction requests from a point of service 12 and registration requests from an authorized registrar 14. The service point 12 can be any provider of financial services such as a bank, post office, foreign exchange and wire service and can include automated systems such as ATMs. Typically, the service point 12 is equipped with a smartcard reader 120 or other storage media reader and is further equipped with one or more biometric readers 124 such as a fingerprint reader, iris scanner and so on. An individual requesting transaction processing is typically required to provide a biometric signature through biometric reader 124 and the signature is authenticated using one or more registered signatures. The registered signatures may be maintained on a centralized database 100 and/or on a smartcard held by the individual. Access to the biometric database 100 and smartcard typically requires the use of authentication keys 104 maintained by the centralized system 10.

An individual may be required to register biometric signatures before receiving service at service point 12. To register signatures, a sample of the registrant's biometric feature or features is captured by reader 144 and submitted to centralized system 10. The centralized system 10 may review previously collected signatures in database 100 before registering a new registrant. In certain embodiments, a smartcard is generated to include encrypted copies of the biometric signatures of the new registrant, the smartcard is then provided to the new registrant. The new registrant may be required to collect the smartcard from a secure location, such as a bank or other financial establishment or from a government office. The new registrant may be required to prove identity by providing a biometric sample that can be matched to the encrypted copies of the biometric signature. In certain applications, the smartcard may be delivered directly to the registrant at a recorded address; however, activation may require providing a biometric sample at a secure location before use is authorized. It is contemplated that the features and functions of registrar 14 may be combined with features and functions of service point 12 for certain types of service providers. However, in many embodiments, the registrar 14 is deployed at certain banks, government offices and other trusted sites.

Centralized system 10 may comprise a plurality of physically and/or geographically distinct subsystems as preferred or indicated by the nature of the application. In that regard, certain components of the centralized system 10 may be performed by different entities including key generation, key repository, biometric signature maintenance, decision making, transaction tracking and reporting components.

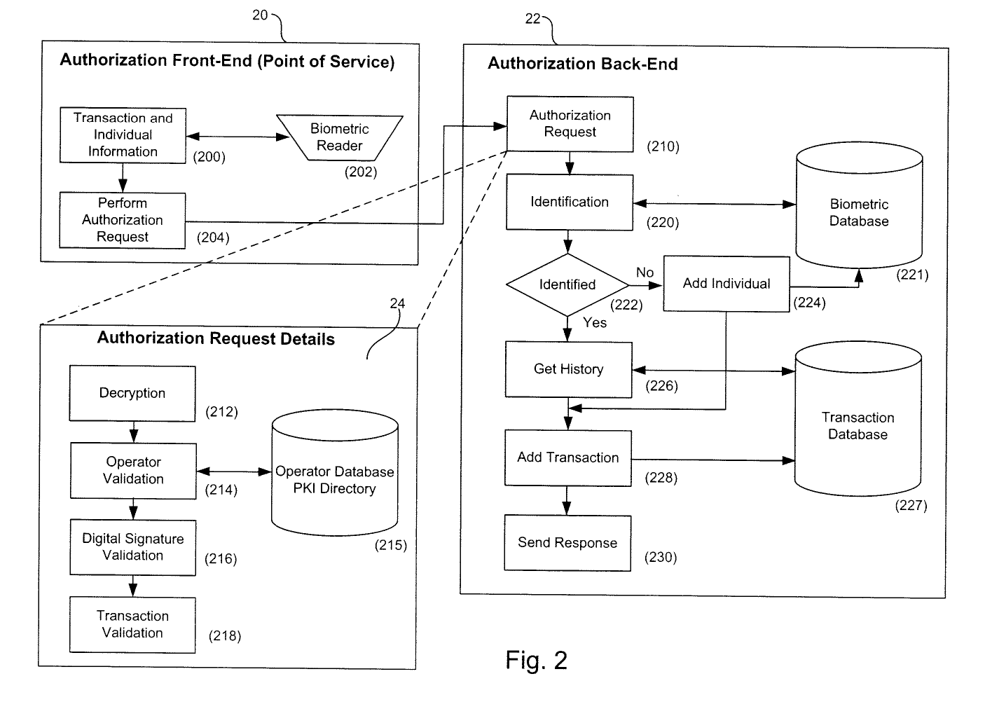

With reference now to FIG. 2, an authorization process is performed in certain embodiments for transactions initiated by users who have not been provided with a smartcard. The authorization process is initiated at a point-of service 20 by an operator who creates a transaction session in a front-end system using an operator smartcard and by providing identification. The operator identification may include a PIN, one or more fingerprints and other biometric information as required. Information provided in relation to operator identification and related to other aspects of the online request is encrypted and signed using the operator's PKI key.

When the operator identification is authenticated, the operator may then initiate transaction processing 204 associated with the user request based on user-provided transaction related information 200 that includes such personal information as is required for authorization purposes. In one example, transactional information 200 includes information entered at the front-end system 20 and includes fingerprint or other biometric data (biometric template) that the user is required to provide on a biometric reader 202 at the point of service.

An authorization request can be prepared 204 for the transaction includes the transaction information 200 comprising user information including the user's biometric template and operator information. The request is typically encrypted for transmission using a suitable encryption scheme such as TripleDES. The encrypted information may be signed using the operator's private RSA key. The request can then be transmitted to the authorization back-end 22. The authorization back-end may comprise one or more servers including Internet servers (web-based), private servers accessible using a private network or some combination of private and web-based servers and networks.

As illustrated in block 24 of FIG. 2, the authorization back-end 22 receives the authorization request at step 210 and decrypts the authorization request at step 212 using the TripleDES key in order to extract the operator information. Based on the extracted operator information, the digital signature can be verified at 214 against a PKI Directory 215 maintained in the back-end 22. At step 216, the digital signature information can be decrypted and validated using keys associated with users of the system and operator keys and based on validation of the digital signature information, the origin of the transaction may be validated at step 218.

Having validated the origin of the transaction at step 218, biometric information provided by the user may be compared at step 220 with information associated with the user in a biometric database 221. When biometric information of a new user is presented, the user can not be identified at step 222 and a new entry may be created in the biometric database 221 at 224 for the user based on the information provided in the request. Additional information may be requested from the user and/or from other sources including government databases, public records and third-party sources. In certain embodiments, the information provided by the new user may match identification of a user previously known to the system but identified as someone different from the current user. Predefined procedures may be implemented to deal with such mismatch including, for example, refusal of transaction, linking of the preexisting user and the new user profiles such that decision making considers transactions provided under either alias, flagging of both preexisting and current users and notification of appropriate authorities.

When the user is properly identified at 222, then a history of prior transactions may be obtained at 226 from a transaction database 227 and the current attempted transaction may optionally be added to the transaction database 227 at step 228. The history of transactions obtained at 226, together with the results from the identification steps 220 and 222 may then be used to obtain an authorization decision. Authorization of the transaction may be permitted based on a combination of factors that includes a combination of the history, the identification of the user, predefined business rules and so on. Authorization may be granted with no warning or indication, granted with a warning or denied. In one example, a predefined rule may stipulate that no more than $10,000 can be accepted from the identified user in a single day and no more than $30,000 can be accepted in a single calendar week or seven day period. The example may also feature a provision based on location of transactions in a particular time frame. For example, the rule may limit the number of transactions accepted from different locations and may further limit the amount of currency further when multiple transaction locations are detected: i.e. the rule may result in a maximum of $15,000 accepted in a single week when three or more different transaction locations are detected. The authorization decision is transmitted to the operator at step 230.

Certain embodiments of the invention provide systems and methods for verifying the origin of financial transactions through an online authorization biometric system. In one example, performance of financial transactions must be signed with the biometric signature/element of the individual that is performing the transaction and the transaction must be subsequently authorized by an online system that typically comprises a central server and a database that maintains information related to individuals that have performed transactions under the system. The information stored in the database for each individual can include one or more biometric templates that can be used to perform a search using a provided template. The templates are typically obtained during registration processes and the number of templates is determined by the type of biometric measurement obtained, the number of sources of the measurements (fingers, palms, irises, etc.) and preconfigured system requirements. Searches are typically in the form of one-to-many (“1:N”) searches and the number of templates stored may vary depending on the biometric method used.

In the example of a fingerprint template, the number of templates stored for pre-registered individuals is typically 10 and the number of templates stored for unknown individual would be the same as the number of templates provided with each transaction. A transaction validated using fingerprints can be configured to require a minimum of two fingerprint templates for each transaction. In another example using iris templates, two templates are typically stored for a pre-registered individual while the number of templates stored for unknown individuals would be the same as the number of templates provided with each transaction. It will be appreciated that, for any transaction, security is greatly enhanced when at least two templates are submitted for validation.

In certain embodiments, a system comprises a plurality of subsystems. One subsystem may include an operator card which is typically issued to a financial institution officer in order to authenticate the officer's identity. The operator card can be used to authenticate and provide digital signatures and to perform online transaction authorizations. The operator card may comprise an embedded integrated circuit chip (“ICC”) that includes or accesses storage and a computational component.

Another subsystem may be a transaction identity subsystem (“TIS”) that comprises components responsible for authorization and storage of transactions in a central database. A transaction authorization subsystem may be provided for authorizing user signatures. Users are typically required to sign their transactions with their biometric information such as fingerprints. The transactions are then authorized by comparison with entries in a biometric database. The biometric database may be a dedicated database or may draw from databases maintained by third parties for which database integrity can be adequately verified. The biometric database and/or a database engine providing access to the biometric database may be maintained on a central server or servers accessible through a network comprising servers, workstations and gateways. Identity of an individual seeking to initiate a transaction can be verified, typically by an exhaustive one-to-many matching search of entries maintained in the database and the individual's transaction history can be retrieved. The transaction history can reflect information identifying multiple transactions at different locations. It will be appreciated that, in some embodiments, database searching can be optimized by, for example, identifying patterns of transactions and locations frequented by individuals and/or by groups or types of individuals.

The system may also comprise a biometric user database. The biometric user database can securely store information regarding transaction authorizations and the individuals involved with the transactions. The system may also comprise a secure transaction subsystem. The secure transaction subsystem typically includes components responsible for secure transaction authentication. Some of these components are situated at locations where transactions are performed. For example, certain components may be located at a currency exchange kiosk where an individual may wish perform transactions.

In certain embodiments, the system comprises authentication devices. In one example, an authentication device includes a card reader and a biometric reader, often connected to a computer or integrated with a custom device such a point of service terminal. The card reader can communicate with an operator card in order to open a session and to receive and relay authorization requests to a central system. The biometric readers can be used to obtain biometric measurements of the individual for transmission to a transaction identity subsystem.

In certain embodiments, the system comprises a secure transaction server that provides an interface between system elements and authentication devices. It is contemplated that the various system components may be combined in one or more physical locations or may equally be distributed across plural locations. Distribution can advantageously provide increased security by maintaining physical and/or separation between components such that a security breach at one physical location will not compromise system integrity and may be more easily detected and corrected.

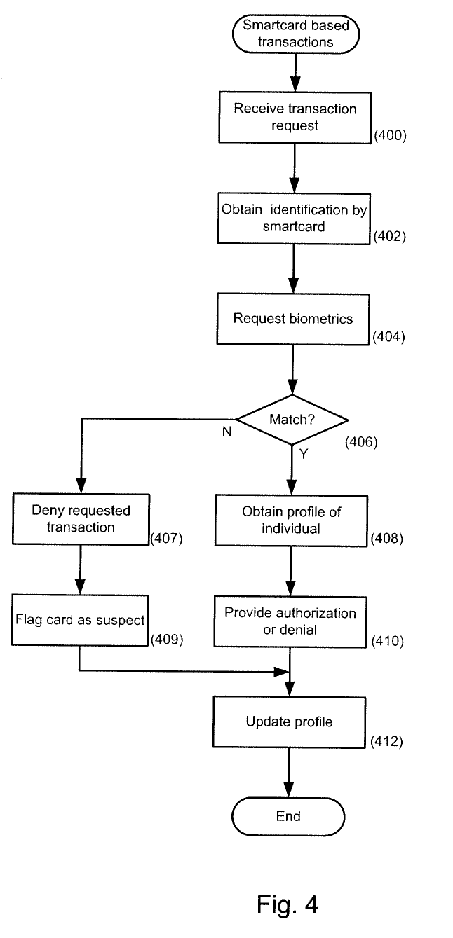

By way of overview, a generalized example of a financial transaction is next described with reference to FIGS. 1 and 4. In certain embodiments of the invention, an individual requesting performance of a financial transaction on a terminal or client device at service point 12 is required at step 400 to provide information describing the transaction. For example, the description may identify an amount of funds of a specific currency to be deposited, converted and/or transferred to another state or location. Typically, the transaction description will include information identifying a recipient and depositor of the funds. At step 402, the individual is required to provide identification. In one example, described in more detail below, the identification and/or confirmation of the identification can be obtained from information stored on a smartcard 121 issued to the individual and readable by smartcard reader 120. The smartcard 121 typically includes name and address of the individual and a reference or registration code that can be used to access pre-registered biometric reference signatures of the individual. The information on the smartcard 121 may be used as identification of the individual and can also be used to confirm information provided at the service point 12 by the individual. The reference code may include one or more authentication keys that can be used to access and decrypt one or more biometric reference signatures of the individual. In some embodiments, some of the reference signatures may be stored in encrypted form in the smartcard 121.

A smartcard 121 may not have been issued to the individual or a smartcard 121 may not be proffered by the individual and verification of identity may be made through system databases 10. To that end, name and address information obtained from the individual, along with account numbers, telephone numbers and/or other identifying information may be submitted in support of a request for identification. Identification may be confirmed, unconfirmed and, in some embodiments, biometric information associated with an identified individual may be obtained from a biometrics repository 100 and returned by the system 10 to service point 12.

At step 404, the service point 12 submits a transaction request to the central authentication system 10, typically through a secured web service. The transaction request may include information describing the transaction and information identifying the requesting individual (as described above), including one or more biometric signatures obtained from the individual using biometric reader/scanner 124. The identifying information may also include the name, address and personal account numbers obtained from the individual and reference or registration codes where available from the smartcard 121.

Upon receiving the transaction request, the system 10 attempts, at step 406, to identify the individual from records maintained in existing databases, including biometrics database 100. Identification can be made using one or more of the biometric signatures obtained from the requesting individual and comparing the signatures with biometric templates stored on the smartcard 121 and/or against biometric information stored in system database 100. If, at step 406, the no match of the provided biometric signature is confirmed, then the authorization of the transaction may be withheld, indicating that the transaction be denied or held pending confirmation of requester identity. In one example, a new user profile may be created if, based on the results of identifying step 406, it is determined that the requesting individual has not used the authentication system previously. The new user profile may permit an identification process to be performed that may ultimately result in issuance of a smartcard 121 to the individual. At step 409, the transaction may be flagged as suspect, pending clearance of a new user or based on indicators of suspicious activity such as unmatched biometric data, excessive transaction frequency and so on. The process then continues by recording the transaction and outcome in a profile associated with the requesting individual at step 412.

If the requester provides a biometric signature that is matched at step 406 with template information maintained on the smartcard 121 and/or system database 100, the requester may be identified as an authenticated individual and an associated profile may be obtained at step 408. The profile typically identifies histories of prior transactions, authorizations, denials and other information. The profile may also include information provided by third parties, including law enforcement, foreign financial institutions and governments, etc. Based on the profile and the transaction request information, authorization or denial of the transaction can be made at step 410 and recorded at step 412.

In certain embodiments, the decision made at step 410 may be an authorization, an authorization with a warning or a denial of service. A denial can be made for a variety of reasons, including detection of a biographic signature match with a person who has been blocked or tagged as suspicious, mismatch of biometric and name/address of the individual, a pattern of transactions conducted by the individual that are determined to be suspicious by the system and for reasons associated with the destination of funds in the transaction.

### Secure Certification of the Origin of Cash

In certain embodiments of the invention, financial transactions can be monitored and controlled using biometric smartcards and certain embodiments provide systems and methods for certifying the identity of an individual wishing to perform cash-based financial transactions using smartcards. Systems and methods typically facilitate cash transaction processing by enabling identification of individuals using a smartcard that maintains biometric templates of the individual. A common identification paradigm may be implemented for secure money transactions and appropriate security assurance can be achieved by verifying the identity of individuals that perform financial transactions through financial institutions, such as exchange windows and banks.

Financial transactions can be controlled and monitored by an authorization system which requires the use of a smartcard that includes one or more biometric templates identifying the authorized smartcard holder. A universal smartcard-based platform can be employed for authenticating identity of the requester and the platform may be deployed across a plurality of participating financial institutions involved in both related and unrelated financial transactions. Additionally, the platform may be trans-nationally deployed to provide smartcard-based identification in connection with certain international transactions such as currency exchanges.

In certain embodiments, a smartcard is used that supports a suite of identity authentication mechanisms that can be used consistently across world-wide financial institutions. Identity information authenticated using the smartcard can then be used as a basis for authorizing transactions in a financial institution. The smartcard is typically issued to an applicant upon completion of a set of registration processes, described in more detail below. The smartcard may comprise an embedded integrated circuit chip that includes memory and computational components. In certain embodiments, two or more classes of smartcards may be employed, including a user card issued to an individual for authenticating the individual's identity when requesting performance of financial transactions at a financial institution; and an operator card that is issued to a financial institution officer for authenticating the identity of the officer and to provide a digital signature in connection with system operations and during performance of online transaction authorizations.

Certain embodiments employ a card issuance and management system to independently prove and register applicant identities, to issue and activate smartcards and to manage and issue encryption keys. The management system may also control and manage various repositories of historical, biographical and demographic information associated with registered smartcard users and financial institutions. The management system typically collects, stores and maintains all information and documentation required for verifying an applicant's identity and information and decisions that permit the identification to be assured. Various types of information are collected from the applicant at the time of registration, as will be described below.

In certain embodiments, smartcard issuance and maintenance systems are used to configure, personalize the physical attributes of a smartcard (visible surface) and the logical/electronically configurable aspects of the smartcard at the time of issuance. The maintenance systems may update and otherwise maintain the smartcards after issuance. In one example, an issuance and maintenance system performs tasks that include the printing of photographs, names and other information on a smartcard, as well as the loading of smartcard applications, biometrics and other data.

In certain embodiments, a key management component is employed to generate key pairs for use in transactions and configuration and to issue and distribute digital certificates containing the public key of a cardholder. The key management component may also manage and disseminate certificate status information and is typically used throughout the life cycle of the smartcards. That is, the key management component is involved in the generation and loading of authentication keys and PKI credentials and is involved when the keys are used for secure operations. The generation and maintenance functions typically include renewing, reissuing and terminating issued smartcards. The key management component is further used for the provisioning of publicly accessible repositories and services such as PKI directories and certificate status responders. These repositories provide information regarding the status of the PKI credentials to a requesting application.

In certain embodiments, a secure transaction system provides secure transaction authentication and may be located where a cardholder may wish perform transactions. For example, transactions may be performed at a bank or at a currency exchange kiosk. An authentication device may be associated with the secure transaction system and may comprise a card reader and one or more biometric reader connected to a terminal or computing device. The card reader communicates with the smartcard to retrieve appropriate information located in the smartcard memory. A biometric reader can capture a biometric measurement from the smartcard user for comparison with biometric data of the registered cardholder that is typically stored in encrypted form in the smartcard memory. Thus, the smartcard can add an additional level of authentication since the smartcard can be used to verify that the user of the smartcard is also the smartcard's registered cardholder. In certain embodiments of the invention, a secure transaction server interfaces between a central system and the authentication device. In certain embodiments of the invention, the secure transaction server can optionally perform additional validation of the captured biometric measurements for the purpose of ensuing that the smartcard is unaltered and uncompromised by tampering.

Referring to FIG. 4 again as illustrative of a typical smartcard-enabled transaction, the authorization process is initiated at step 400 when a transaction request is received at a financial institution or service point. An individual requesting performance of a transaction may, for example, wish to transfer or exchange funds. At step 402, the requesting individual is prompted to provide identification and provides in response a smartcard for the purposes of identification. In some embodiments, the transaction request may be initiated when a requester submits a smartcard identification and is subsequently prompted to select a transaction type; the selection of transactions available to a specific individual may be based on the identification of the requester and a history of prior transactions, warnings or other information. However, in certain embodiments, it is preferable to identify the transaction request first in order to create a record of the transaction request in relation to the requester and/or smartcard.

In response to the prompt for identification, the individual may insert or otherwise connect a smartcard to a reader and may additionally provide other information. At step 404, the system typically requests a biometric signature of a type indicated by the smartcard. For example, if the smartcard maintains one or more copies of fingerprint templates, the individual is requested to provide a sample of a fingerprint. In certain embodiments, biometric signatures may be collected automatically and without prompting. For example, iris scan and face scans may be collectable using a passive scanning system (based on a video camera). In another example, provision of a fingerprint may initiate the service point could be collected and/or fingerprints may be collected using a keypad or touch panel display adapted to capture fingerprint information during data entry. The biometric signature can be collected, processed and stored for comparison with recorded template biometrics of the cardholder or other individuals.

At step 406, the system determines whether the biometric signature provided by the smartcard user matches one of the biometric templates stored on the smartcard. For example, a smartcard may store a biometric template for each of a set of fingerprints and/or palm prints of a cardholder. If no match is obtained, the transaction is typically denied at step 407. In some embodiments, the requester may optionally be requested to resubmit the biometric signature or a different biometric signature. In at least some embodiments, failure of the requester to provide a valid biometric signature may optionally result in a flag being set at step 409 in the smartcard and/or in the system. The flag indicates a potential misappropriation of the smartcard and may require a cardholder to submit to a re-registration or revalidation process before the card can be used again for authenticating the cardholder. In some embodiments, revalidation may be performed at a trusted location, such as a bank or government office.

At step 408, after a match of biometric signature with a biometric template has been confined, information associated with the individual is retrieved. The information may include a profile of the individual and a transaction history associated with the individual. Based on the history and other information associated with the profile, the transaction request can be approved or denied. Regardless of the outcome of the biometric matching or approval steps 406 and 410, the profile of the cardholder is updated at step 410 with a log of the transaction request. Thus, the profile maintains current information associated with activities of the cardholder involving the smartcard. A portion or summary of the profile may be maintained on the smartcard. The description of the current transaction and the decision result is typically stored on the system and on the card and becomes part of the transaction history for that individual at step 412. When a transaction is authorized, it can be securely signed and a certificate may be generated that guarantees the origin of the transaction.

Smartcard Mapping and Development through Secure Definition Files

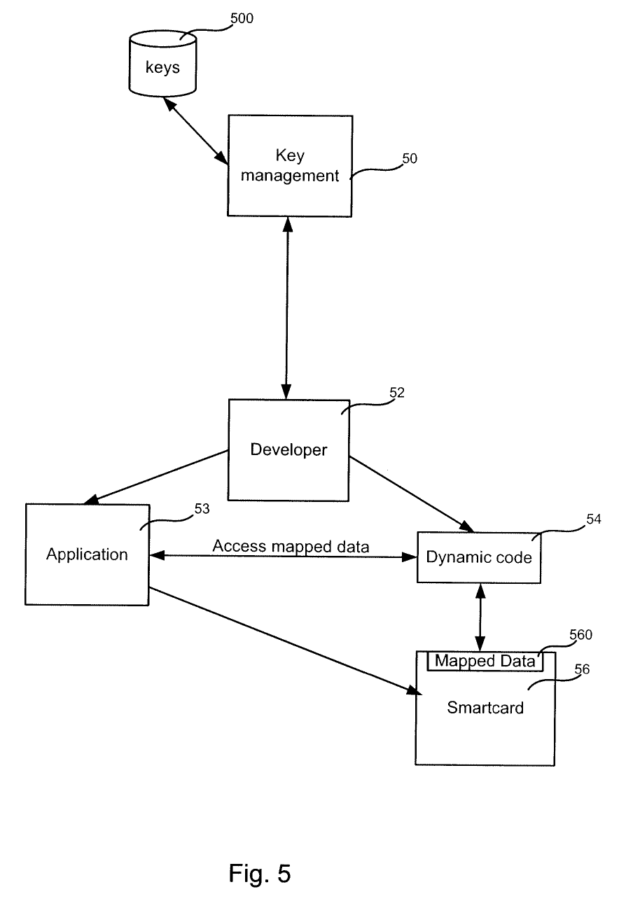

Certain embodiments of the invention provide systems and methods for facilitating production of encrypted files that include a design of a smartcard mapping as well as certain information to be stored in the smartcard. With reference to FIG. 5, a developer 52 can employ encrypted files without direct ability to decrypt the files in order to create applications 54 that interact with smartcards 56. A key management system 50 maintains keys 500 for the smartcard 56 and developer 52 and can provide only those keys necessary to enable a dynamic application 54 to be generated by the developer 52 and executed on the smartcard 56.

The developer 52 may then create an application 53 for smartcard 56 that accesses encrypted data 560 on smartcard 56. The encrypted data 560 can be mapped by a smartcard mapping undisclosed to developer 50. However, developer 50 is provided access to dynamic code that can access and decrypt mapped data 560 and provide the decrypted data to application 53. Therefore, neither developer 50 nor application 53 know how encrypted data 560 is mapped within smartcard 56, but application 53 can issue a request to dynamic code 54 that retrieves and/or stores encrypted data 560 as mapped by a predefined, secret smartcard mapping.

Dynamic code 54 is typically provided as code inside or in association with the predefined smartcard mapping definition file that can be used to create applications. It is contemplated that the use of dynamic code 54 will simplify application development and provide a consistent manner of addressing content within smartcards, whether content is encrypted, decrypted or unencrypted. For example, developer 52 can be provided access to a function that reads a single field from smartcard 56. The developer does not have to know the format in which the information in the requested field is stored on the smartcard 56 because dynamic code 54 in the smartcard definition file can perform any necessary format conversions as well as locate the requested field.

In one example, an embodiment of the invention can be used to create a sample mapping for the MPCOS operating system. The methods and systems described in this regard can be applied to any operating system and to memory cards. Furthermore, the description will include a mapping definition written in an XML file format although it is contemplated that a wide variety of programming languages and file formats can be used.

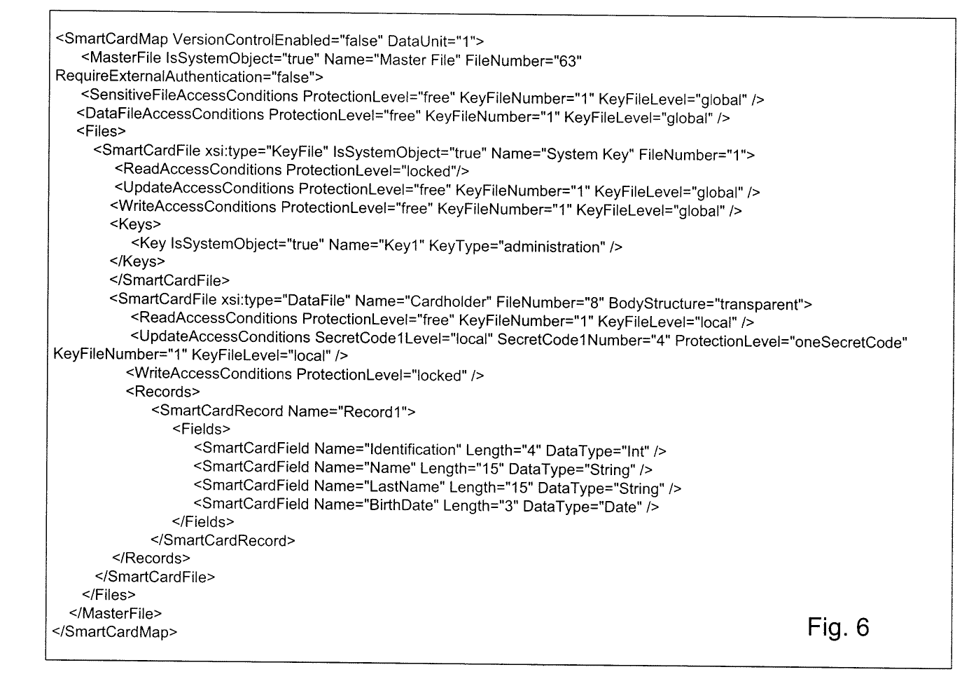

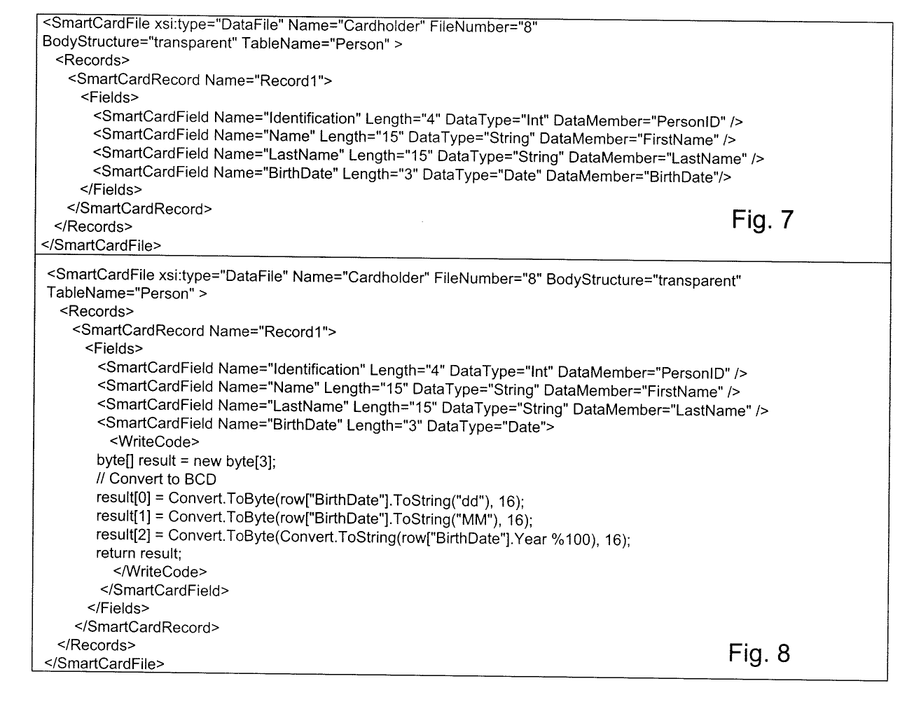

With reference also to FIGS. 6 and 7, certain embodiments employ XML file formats that comprise information related to a smartcard mapping that can include a file structure and access conditions for each file. The smartcard mapping file is encrypted into a file, typically with a predefined extension such as “.scm.” Encryption can be performed using two or more passwords including one password for accessing the mapping and a second password for editing the mapping. The cryptographic key values and secret codes required to access the card can be stored in multiple separate encrypted files with an extension such as “.scmk.” A single file can contain all keys and secret codes but may also contain only a subset of these values depending on the access privileges that the application 54 being developed must have on the smartcard 56. Developers 52 can then be provided with the smartcard mapping file “Test.scm” and the smartcard mapping key file “Test.scmk” that includes keys necessary for development. Developers 52 are typically prohibited from viewing the cryptographic keys or secret codes for the mapping and don't need to know the design of the mapping or the access conditions for each file in order to interact with the smartcard 56.

In certain embodiments, the application 54 can access the files to read and write information on the smartcard 56 using the file names and field names. This mode of access requires only that developers 52 know the name of the files and fields with which the application 54 should interact. In order to access these files, certain access conditions must be satisfied but developers 52 need not know the details of these conditions since they need only load the security keys into the mapping.

In order to read the last name of the cardholder from the smartcard 56, only the full path of the corresponding field (i.e. “Cardholder\Record1\LastName”) need be known in the example mapping shown in FIG. 6. A path code can be provided to read the last name as follows:

map.LoadKeyFile(“Test.scmk”, password);
map.ReadDataFile(“Cardholder”);
string lastName = (string)map.FieldValue(“Cardholder\\Record1\\
LastName”);

It will be appreciated by considering the example of a mapping definition that, in order to read from the cardholder file the ReadAccessConditions must be satisfied; that is, the local secret key must be supplied. A developer 52 need not be aware of this condition but the key file “Test.scmk” loaded into the map prior to reading from the card must include the value for local secret key 1 in order for the read operation to succeed.

In certain embodiments, the application may access files to read and write information on the smartcard 56 using data binding through a data source. This method of interaction with the smartcard 56 requires only that developers know the data source structure that will be used to write information onto, or read information from a smartcard 56. This mode is conceptually similar to modes of access that use file names and field names, except for the use of data binding, which will be described in more detail below.

In the latterly described examples of file access, smartcard mapping design files contain the information required to interact with a smartcard without revealing information about the layout, access conditions, secret keys or codes. Reading from a field can be performed with a few programmed instructions and access conditions can be disregarded. In conventional systems, a developer must generate specific code that satisfies access conditions and must know the mapping design. Furthermore, the developer must have access to secret keys and codes and provide a means to securely store these values in order to maintain security. The procedures enabled by certain aspects of the presently claimed invention can greatly simplify smartcard development and can provide greatly improved security.

Smartcard Data Binding using Dynamic Code in the Mapping

Data binding can be used in certain embodiments to establish a connection between smartcard fields and business logic. Data binding may be used to place server or local data into forms or other UI controls. According to certain aspects of the invention, smartcards can be configured to use data binding for placing data into smartcards files. Accordingly, certain embodiments of the invention provide a mapping definition for data binding. The mapping definition typically contains information about files, records and fields within a smartcard. In certain embodiments defining data binding for a field includes defining the table name on the data source that is bound to a particular file in the smartcard. Additionally or alternatively, definition can be made of a data member in the table of the data source that is bound to a particular field in the smartcard file.

In one example, a card mapping can be defined to include a data file named “Cardholder” and an XML file may include a definition of the structure for the Cardholder file shown in FIG. 7. In the example, the file Cardholder contains a single record named “Record1” which contains four fields. The Cardholder file on the smartcard is bound to the table “Person” on the data source and the field named “Name” in the Cardholder file has been bound to the data member “FirstName” in the “Person” table in the data source. In order to perform simple data binding, the application would only need to provide a data source that contains a table named Person which in turns contains fields for “PersonID.” “FirstName,” “LastName” and “BirthDate” with data types that correspond to the data types defined in the mapping. The data binding mechanism can provide and interact with data in the smartcard in a simple and consistent manner. Thus, aspects of the present invention can greatly simplify the exchange of information with smartcard files. Little or no development effort may be necessary and, typically, no modification is needed on the data source.

In certain embodiments, additional manipulation may be performed on the data before it is exchanged with the smartcard. In one example, it may be desirable to store more than one field in the data source on a single field in the smartcard. In another example, it may be preferred that a date is stored on a smartcard field in a different manner from the method of storage on the data source. Accordingly, certain embodiments of the invention employ dynamic code that can be defined in the mapping itself The use of dynamic code permits applications to be extended through the use of code that need not be compiled into the application, thereby allowing users to customize applications and permitting developers to easily and dynamically update code.

In certain embodiments, a smartcard mapping design can employ a dynamic code execution scheme to convert information between the smartcard and the data source. The code to be executed can be compiled at run-time and may be stored as simple text in the smartcard mapping definition file. In the example of FIG. 7, assuming the birth date of the cardholder may be stored in binary coded decimal (“BCD”) format using three bytes. A first byte may represent the year, a second byte can represent the month and the third byte may represent the day. An example of C# instructions required to convert from a DateTime object in the data source to a BCD format may be stated as:

byte[ ] result = new byte[3];
// Convert to BCD
result[0] = Convert.ToByte(date.ToString(“dd”), 16);
result[1] = Convert.ToByte(date.ToString(“MM”), 16);
result[2] = Convert.ToByte(Convert.ToString(date.Year % 100), 16);

For dynamic code to be incorporated into the smartcard mapping, a function prototype can be defined for all dynamic functions that will be compiled and executed at runtime. For example, the prototype for all functions can be:
public byte[] DynamicFunction(DataRow row),
   where row is the data row in the data source that is bound to the particular smartcard field. The body of the code to convert the BirthDate field in the data row to a 3 byte BCD format could then be akin to:

byte[ ] result = new byte[3];
// Convert to BCD
result[0] = Convert.ToByte(row[“BirthDate”].ToString(“dd”), 16);
result[1] = Convert.ToByte(row[“BirthDate”].ToString(“MM”), 16);
result[2] = Convert.ToByte(Convert.ToString(row[“BirthDate”].
Year % 100), 16);
return result;

This definition can now be easily added to the smartcard mapping design as simple text.

An example of a complete definition in XML format is shown in FIG. 8. In order to perform data binding, an application need only provide a data source that contains a table named Person which in turns contains a field name BirthDate and whose data types correspond to the data types defined in the mapping. The data binding mechanism can then present and interact with data in the smartcard in a simple and consistent manner.

### Encryption Key Structure

For the purposes of this description, encryption key structure generally describes the type and quantity of public and private keys used in a transaction, locations in which keys are kept and rules and procedures for managing keys including methods for generating keys, processes and rules for authorizing key generation and processes for securely transmitting keys to a card manufacturer and/or card issuer.

In certain embodiments, elements of smartcard security may be handled by the smartcard's operating system (“SCOS”). The SCOS typically includes commands that implement cryptographic functions that can be used in forming a complete security scheme for an application. This security scheme can include authentication, calculation of temporary/session keys, certificate generation, signatures and secure messaging.

In some embodiments, keys stored on the smartcard can be used in performing a plurality of processes, including encrypting/decrypting secret codes/keys, computing certificates and signatures and secure messaging. Keys can be supplied to the smartcard in key files that are initialized during the card personalization. Keys may also be generated by the smartcard operating system, typically for the purpose of creating temporary keys. Information is stored in files in the smartcard and access to the files is protected by secret codes. The secret codes are typically stored in specific files inside the card, called secret code files in this description.

In certain embodiments, access conditions define the level of protection for each file and access conditions define certain characteristics of the smartcard, including the number of secret codes that must be submitted before access is granted to the file. The number of secret codes may vary by type of access requested. For example, certain files types may require no secret codes, one or two or more secret codes based on whether the access type is create, read, write or update access. Access conditions can also determine the cryptographic key used to generate session keys for all secure messaging with the file where secure messaging is a cryptographic process that secures data transmissions with the smartcards.

In certain embodiments, a requirement to present secret codes can be imposed prior to selecting a file. A successful submission of secret codes is typically stored in an authorization register and results in a determination if access to a file should be granted. Such determination may be made by comparing the secret codes in the authorization register with predefined codes required by the access condition.

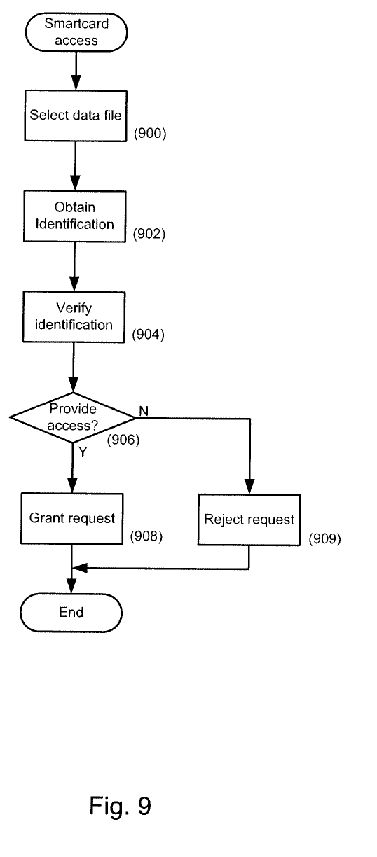

In certain embodiments, data protection conditions can be defined for each file by an issuer of an application. The example shown in FIG. 9 assumes that an application issuer may create a data file requiring a point of service terminal to perform certain steps before access to data is permitted. The point of service terminal is presumed to be equipped with a smartcard reader in the example. At step 900 a parent file is initially selected and, the cardholder is prompted to enter a PIN code at step 902. In this example, read access to this file is protected by PIN code such that read access is denied unless a valid PIN code is presented. The PIN code presented by the cardholder is provided to the smartcard at step 904. The smartcard may then compare the PIN code with the corresponding secret code stored in a secret code file in the smartcard at step 906 and grant access as appropriate at step 908; otherwise access is denied at step 909.

In certain embodiments, smartcards are initialized following an embedding step in production of a smartcard process. The initialization process comprises writing basic card information including a card serial number, a system file structure, and system keys. System keys are typically protected by a diversified key provided for the card. Upon initialization, the personalization flag of the card is not set; i.e. the flag is set to 0. The flag is typically set (e.g., to 1) upon completion of personalization. The setting of the flag indicates that the card has been switched to user mode. Keys initialized during card personalization can be loaded into key files. Access conditions to files can be modified in association with the personalization. For example, certain files may be locked to prevent any further modification.

### Personalization

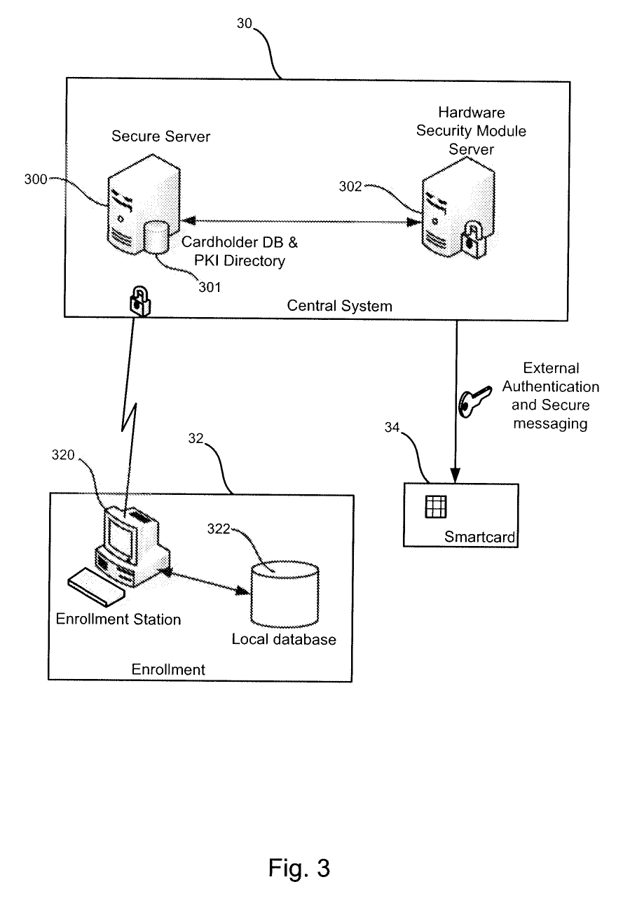

With reference to FIG. 3, certain aspects of the invention permit personalization to be performed by a card personalization facility and/or by card providers at the card-provider location. Thus, aspects of the enrollment process can be shared among plural facilities. In another example, multiple facilities can comprise the central system 30 and provide different sets of keys to a smartcard. Personalization at a personalization facility typically comprises generation of diversified keys at the personalization facility using a secure key diversification ceremony. The diversified keys may then be stored in a hardware security module (“HSM”). In the ceremony, each key holder secretly enters their component or part of the final key into the HSM using HSM server 302. The HSM is responsible for securely storing the keys and related information. The HSM server 302 provides keys used during the personalization process in a secured manner and any information regarding the cardholder that is required for graphical personalization and electronic personalization must be transmitted in a secure way to the personalization plant. The information regarding the cardholder is typically obtained directly from the secure database 301. In one example, keys and other information can be encrypted using PGP and an asymmetric key. Typically, in-house personalization performed by a card provider, uses an HSM server 302 to store diversified keys and a key ceremony described above can be performed in-house in a similar manner to that described.

### Encryption and Signatures

In certain embodiments, information maintained for a cardholder includes a personal RSA key for the user. The personal RSA key can be used to sign transactions performed with the card. Typically, the RSA key is an asymmetric key used in PKI that is generated on a secure database (e.g. a PKI directory) when a new cardholder record is added to the database. In many embodiments, information including RSA keys can be added to the secure database only after the information contained has been processed through the enrollment and biometric verification processes and has been determined to be a non-duplicative record.

The cardholder RSA key may be stored in a secure file inside the smartcard during personalization. Upon completion of personalization, the secure file is locked for both writing and updating and the key cannot be changed after locking. Read access for the file is conditioned upon presentation of a required secret code and the use of secure messaging. The secret code is typically provided in the form of a PIN submitted by the cardholder and keys required for secure messaging must typically be provided by the terminal.

In certain embodiments, an application can generate a valid signature for a transaction only if the cardholder identity has been adequately verified. The PIN entered by the cardholder must typically be used in order to access the cardholder's private RSA key necessary for signing the transaction information. The central database can verify the signature using the PKI directory. Additionally a symmetric key can be used for encryption of all communications with the central system. The symmetric key may be stored in the central secure database and in smartcards supported by the system. The symmetric key can be stored in the card during personalization and use of the symmetric key may also require secure messaging and secret code presentation.

### Additional Descriptions of Certain Aspects of the Invention

Certain embodiments of the invention provide methods for authorizing a financial transaction. In some of these embodiments, the method comprises receiving a request for execution of the financial transaction from a requesting party, the request including at least one biometric signature of the requesting party, identifying the requesting party based on the at least one biometric signature, determining a history of prior transactions executed on behalf of the requesting party, searching for predefined patterns of transactions in the history of prior transactions, and authorizing the financial transaction based on the presence or absence of certain predefined patterns. In some of these embodiments, one or more of the at least one biometric signature is encoded on a smartcard. In some of these embodiments, the one or more biometric signature encoded on the smartcard is encrypted. In some of these embodiments, the step of identifying includes obtaining a biometric sample from the requesting party and comparing the biometric sample with one or more biometric template encoded on a smartcard.

In some of these embodiments, the step of identifying includes obtaining a secret code from the requesting party, wherein the secret code is used to decrypt the one or more biometric template. In some of these embodiments, certain predefined patterns comprise suspicious patterns and the financial transaction is authorized based on the absence of the suspicious patterns. In some of these embodiments, suspicious patterns include a plurality of similar transactions performed at multiple locations. In some of these embodiments, the financial transaction and the plurality of similar transactions include a currency exchange. In some of these embodiments, the plurality of similar transactions occurred within a predefined time prior to the receiving the request. In some of these embodiments, the plurality of similar transactions transferred an aggregate sum of money exceeding a predetermined threshold. In some of these embodiments, the suspicious patterns include a plurality of similar transactions directed to a common receiving party. In some of these embodiments, the receiving party received funds in excess of a predetermined threshold amount. In some of these embodiments, the suspicious patterns include one or more similar transactions directed to the common receiving party by each of a plurality of different parties. In some of these embodiments, the common receiving party and the requesting party are located in different jurisdictions. In some of these embodiments, the certain predefined patterns include patterns predefined by a government agency. In some of these embodiments, the financial transaction is authorized based on the presence of a pattern of previously authorized similar transactions.

Certain embodiments of the invention additionally or alternatively provide systems for authorizing financial transactions. In some of these embodiments, the systems comprise a service point configured to receive a biometric signature from a party requesting performance of a financial transaction, a repository of biometric reference signatures corresponding to a plurality of users of the system, a history of transactions identifying previous transactions associated with the plurality of users, and an authorization system configured to identify the party based on the biometric signature and the biometric reference signatures. In some of these embodiments, the authorization system conditions authorization of the financial transaction upon a successful identification of the party and patterns of previous transactions performed by the party. In some of these embodiments, the biometric signature is encrypted and encoded on a smartcard. In some of these embodiments, the biometric signature is provided by the requesting party and the biometric reference signatures include an encrypted reference signature stored on a smartcard. In some of these embodiments, the reference signature stored on the smartcard can be decrypted using a secret code corresponding to, or associated with an authorized user of the smartcard.

Certain embodiments of the invention provide methods for authorizing a financial transaction. Some of these embodiments comprise receiving a request for execution of the financial transaction from a requesting party, the request including at least one biometric signature of the requesting party, identifying the requesting party based on the at least one biometric signature, searching for predefined patterns of transactions in a history of prior transactions executed on behalf of the requesting party and optionally authorizing the financial transaction based on the presence or absence of certain predefined patterns. In some of these embodiments, one or more of the at least one biometric signature is encoded on a smartcard. In some of these embodiments, the one or more biometric signatures are encrypted.

In some of these embodiments, the step of identifying includes obtaining a biometric sample from the requesting party and comparing the biometric sample with the at least one biometric signature, the at least one biometric signature including a biometric template encoded on a smartcard. In some of these embodiments, the step of identifying includes decrypting the biometric template using a secret code associated with the requesting party. In some of these embodiments, the predefined patterns comprise suspicious patterns and the financial transaction is authorized based on the absence of the suspicious patterns. In some of these embodiments, the suspicious patterns include a plurality of similar transactions performed at multiple locations. In some of these embodiments, the financial transaction and the plurality of similar transactions include a currency exchange. In some of these embodiments, the plurality of similar transactions occurred within a predefined time prior to the receiving the request. In some of these embodiments, the plurality of similar transactions caused transfer of an aggregate sum of money exceeding a predetermined threshold.

In some of these embodiments, suspicious patterns include a plurality of similar transactions directed to a common receiving party. In some of these embodiments, a common receiving party received funds in excess of a predetermined threshold amount. In some of these embodiments, suspicious patterns include one or more similar transactions directed to the common receiving party by each of a plurality of different parties. In some of these embodiments, a common receiving party and a requesting party are located in different jurisdictions. In some of these embodiments, certain predefined patterns include patterns predefined by a government agency. In some of these embodiments, financial transactions are authorized based on the presence of a pattern of previously authorized similar transactions.

Certain embodiments of the invention provide systems for authorizing financial transactions, certain of these systems implementing the methods and processes described herein. Some of these embodiments comprise a service point configured to receive a biometric signature from a party requesting performance of a financial transaction, a repository of biometric reference signatures corresponding to a plurality of users of the system, a history of transactions identifying previous transactions associated with the plurality of users and an authorization system configured to identify the party based on the biometric signature and the biometric reference signatures. In some of these embodiments, the authorization system conditions authorization of the financial transaction upon a successful identification of the party and upon patterns of previous transactions performed by the party.

In some of these embodiments, biometric signatures include a template encrypted and encoded on a smartcard. In some of these embodiments, biometric signatures may be provided by a requesting party and the biometric reference signatures can include an encrypted reference signature stored on a smartcard. In some of these embodiments, reference signatures stored on the smartcard can be decrypted using a secret code corresponding to an authorized user of the smartcard.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method for authorizing a financial transaction, comprising the steps of:
receiving a request for execution of the financial transaction from a requesting party, the request including at least one biometric signature of the requesting party;
identifying the requesting party based on the at least one biometric signature;
searching for predefined patterns of transactions in a history of prior transactions executed on behalf of the requesting party; and
optionally authorizing the financial transaction based on the presence or absence of certain predefined patterns.

2. The method of claim 1 wherein one or more of the at least one biometric signature is encoded on a smartcard.

3. The method of claim 2 wherein the one or more biometric signature encoded on the smartcard is encrypted.

4. The method of claim 1 wherein the step of identifying includes:
obtaining a biometric sample from the requesting party; and
comparing the biometric sample with the at least one biometric signature, the at least one biometric signature including a biometric template encoded on a smartcard.

5. The method of claim 4 wherein the step of identifying includes decrypting the biometric template using a secret code associated with the requesting party.

6. The method of claim 1 wherein the certain predefined patterns comprise suspicious patterns and the financial transaction is authorized based on the absence of the suspicious patterns.

7. The method of claim 6 wherein the suspicious patterns include a plurality of similar transactions performed at multiple locations.

8. The method of claim 7 wherein the financial transaction and the plurality of similar transactions include a currency exchange.

9. The method of claim 7 wherein the plurality of similar transactions occurred within a predefined time prior to the receiving the request.

10. The method of claim 7 wherein the plurality of similar transactions caused transfer of an aggregate sum of money exceeding a predetermined threshold.

11. The method of claim 6 wherein the suspicious patterns include a plurality of similar transactions directed to a common receiving party.

12. The method of claim 11 wherein the common receiving party received funds in excess of a predetermined threshold amount.

13. The method of claim 12 wherein the suspicious patterns include one or more similar transactions directed to the common receiving party by each of a plurality of different parties.

14. The method of claim 11 wherein the common receiving party and the requesting party are located in different jurisdictions.

15. The method of claim 10 wherein the certain predefined patterns include patterns predefined by a government agency.

16. The method of claim 1 wherein the financial transaction is authorized based on the presence of a pattern of previously authorized similar transactions.

17. A system for authorizing financial transactions, comprising:
a service point configured to receive a biometric signature from a party requesting performance of a financial transaction;
a repository of biometric reference signatures corresponding to a plurality of users of the system;
a history of transactions identifying previous transactions associated with the plurality of users; and
an authorization system configured to identify the party based on the biometric signature and the biometric reference signatures,
wherein the authorization system conditions authorization of the financial transaction upon a successful identification of the party and upon patterns of previous transactions performed by the party.

18. The system of claim 17 wherein the biometric signature includes a template encrypted and encoded on a smartcard.

19. The system of claim 17 wherein the biometric signature is provided by the requesting party and the biometric reference signatures include an encrypted reference signature stored on a smartcard.

20. The system of claim 17 wherein the reference signature stored on the smartcard can be decrypted using a secret code corresponding to an authorized user of the smartcard.
